(19) United States
(12) Patent Application Publication
(10) Pub. No.: US 2005/0147217 A1
(43) Pub. Date: Jul. 7, 2005

(54) Method and system for implementing a speech service using a terminal device and a corresponding terminal device

(75) Inventor: Petri Ahonen, Jyvaskyla (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/026,966

(22) Filed: Dec. 30, 2004

(30) Foreign Application Priority Data
Jan. 2, 2004 (FI) 20045001

(51) Int. Cl. H04M 11/00; H04M 1/64

(52) U.S. Cl. 379/88.17; 379/88.14; 379/88.13

(57) ABSTRACT

The invention relates to a method and system for implementing a speech service using a terminal device, in which the terminal device sends a call/service request to a server for the speech service, the server sends speech alternatives corresponding to the service to the terminal device as a special text file, the text file is parsed and the alternatives are converted to speech and enunciated to the user as speech messages by the terminal's loudspeaker devices, the user uses the terminal to select a speech alternative, the terminal sends the server a service request corresponding to the selection.

### BACKGROUND OF THE INVENTION

1. Field of the Invention

The present invention relates to a method and system for implementing a speech service using a terminal device and a corresponding terminal device, in which
the terminal device sends a call/service request to a server for the speech service,
the server sends speech alternatives corresponding to the service to the terminal device,
the speech alternatives are enunciated to the user as speech messages by the terminal's loudspeaker devices,
the user uses the terminal to select a speech alternative,
the terminal sends the server a service request corresponding to the selection.

The invention also relates to a terminal device implementing the service.

2. Description of the Prior Art

Automatic robot telephone services are nowadays widely used. These services, in which a telephone robot creates a tone response, use circuit-switched calls for control. The user controls the service by keying in numbers, which the terminal codes as a DTMF tone. The service progresses according to the selection of the consecutive alternatives provided by the speech robot. No information can be shown on the display and it is difficult to provide a prerecorded sound response in many different languages. The sound response and the DTMF tone travel in the speech channel, thus reserving the air channel for the entire duration of the service. This wastes the resources of the network.

Document WO 02/087098 A1 discloses a VoiceXML application. The bandwith resources may be used more efficiently, when voice response services are processed close to the terminal using VoiceXML-standard. Information is sent as compact data messages across the network. Like in other VoiceXML applications e.g. in voice portals, a telephone subscriber here receives voice messages from a special server, here called a subscriber station, which converts VoiceXML messages into speech and possible speech back to compact data messages. The terminal responses are DTMF tone signals, which are interpreted by the IVR-service provider. Requests and responses of the terminal are usually handled by the service provider, but it is also proposed to distribute a tree of messages to the base station, where the tree is handled according to responses from the terminal. The terminal responses are always audio type.

### SUMMARY OF THE INVENTION

The present invention provides a new method and system for implementing a speech service using a terminal device and a new terminal itself. The characteristic features of the method according to the invention are stated in claim 1, those of the system in claim 8, and those of the terminal device in claim 14. Transferring the speech formation to the terminal, considerably simplifies the control of the different languages in the service. The structure of services can be optimized and they can be significantly improved, which will become apparent later. In one embodiment, a text file of the speech service is stored in the terminal for later use. In a further application, one or more menus are browsed locally. The validity of the stored file is checked separately. In this case, the term “text file” should be understood to generally cover data coded as characters.

In one embodiment, the DTMF selection and/or the network's sound responses are simulated to create sound effects corresponding to the user. Besides speech messages, the user can be shown a text or graphic menu on the display, in order to facilitate the selection. The text on the display is synchronized with the current speech message. Terminal responses are sent as data messages not as voice messages to the server.

In another embodiment of the terminal, an existing TTS (text-to-speech) module is used to convert the message to speech. Such modules are optimized for the selected language. In one embodiment, the services are coded for the server as XML pages. Applications include VOIP telephones and mobiles stations.

The method according to the invention can be applied in different kinds of networks. The transmission link between the terminal and the server can be of any type at all. In addition to traditional automatic telephone services, the method according to the invention can be used much more extensively, because it provides numerous technical advantages. The language can be selected by the user or can be selected automatically, for example by using the telephone's language settings, or other chosen criteria. The language selection controls the text pages sent by the server and the programming of the TTS module's parameters. In one embodiment, the speech and/or language model (algorithm) of the TTS module can be downloaded over the network.

In another embodiment a menu corresponding to the selection alternative is shown as an additional option on the terminal's display. Thus, the terminal equipment has a display element and software for this function.

### BRIEF DESCRIPTION OF THE DRAWINGS

In the following, the invention is examined with reference to the accompanying drawings which show some embodiments of the invention.

FIG. 1 shows the service system in its entirety

FIG. 2 shows the structure of the terminal's XML parser

FIG. 3 shows a flow diagram for sending the service menu to the terminal

FIG. 4 shows a flow diagram of the processing of the user's selection

### DETAILED DESCRIPTION OF CERTAIN ILLUSTRATED EMBODIMENTS

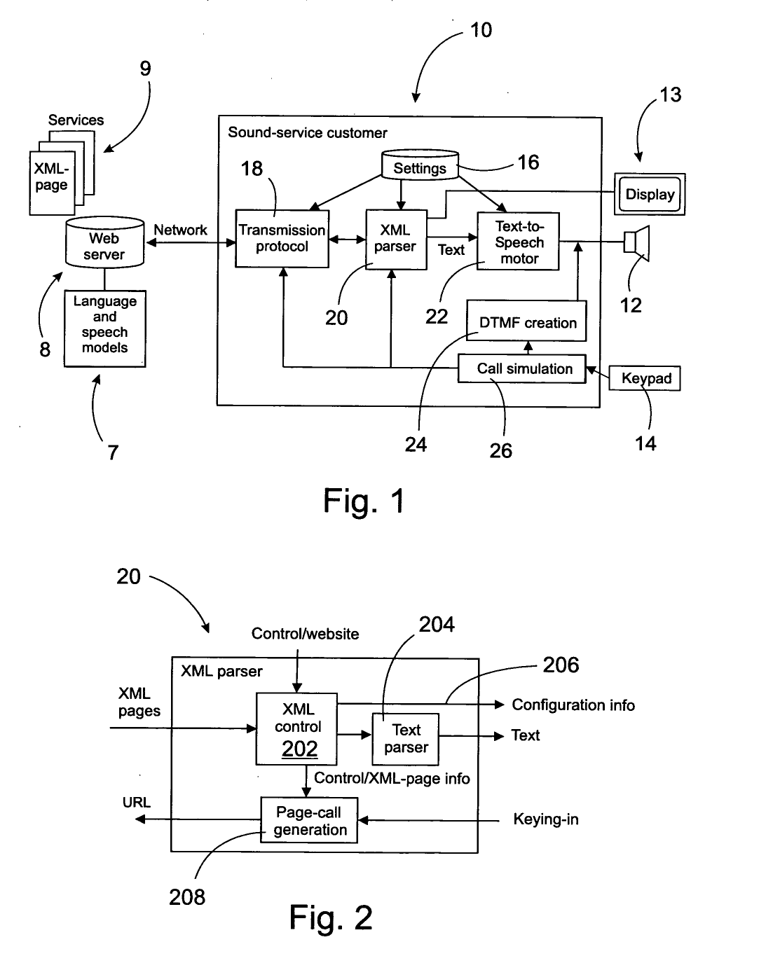

In the example of FIG. 1, the terminal is shown with the reference number 10 and the server with the reference number 8. One or more XML files 9 are stored in the server 8. This has a telecommunications link with the terminal, for example, with the aid of a wireless mobile communication system. The terminal 10 has a special speech-service-client unit, which is shown as its own box. Primarily, this has software means 16 for making pre-settings. These settings include the access point for the selected service, i.e., for example, an IP address, the server addresses of the language and telephone model, the username, the password, the language selection, and the operating settings of the terminal, such as the virtual speech parameters, the display fonts, etc.

Searches for XML pages and page requests are processed in a relay protocol unit 18. From here, each XML page retrieved is taken to an XML-page parser 20, the more detailed construction of which will be examined later in connection with FIG. 2. The XML parser 20 feeds the text to be converted to speech to the TTS (Text-to-Speech) module 22, from where the terminal's loudspeaker devices 12 (any proper sound device) enunciated it to the user. At the same time, a menu corresponding to the selection alternative is shown as an additional option on the terminal's 10 display 13. This text presentation is not at all exactly the same as the spoken version, instead the text version should be optimized as its own totality. The XML file 9 can include a ready text version, or this can be formed only in the terminal, according to the selected rules. Naturally, a graphical menu can be used, if permitted by the terminal.

The TTS speech parameters can be controlled by both the user and the server. Typically, the user can select a “virtual speaker”. The technology of the TTS elements is widely known. The construction of the TTS module generally consists of algorithms and of the parameter models that control the algorithms. There are generally two algorithms (and model types), one of which is a part that simulates the rules and structures relating to the language used, and the other is a part that simulates a speaker's speech. There is generally one language model for one language and one speech model for one speaker. For TTS to operate in the terminal, there should be at least these two models (language and speech model). Patent publications U.S. Pat. No. 5,555,343 and EP 598598 disclose both speech conversion and preprocessing of the text before conversion. A novel feature in the present invention is that, in one embodiment, the language and/or speech model is downloaded to the terminal over a network. This permits new languages and types of speaker to be added afterwards to each speech service. Alternatively, it is easy to update the algorithms used. In FIG. 1, the language and speech models 7 are stored on the same server 8 as the services 9, though naturally they can all also be located on different servers.

In the embodiment of FIG. 1, the user enters their selection with the aid of a keypad 14. As in known speech services, the input is numbers, which are processed in the call-simulation unit 26. When envisaging complete imitation, DTMF tone codes are produced by the unit 24 from the number selection and fed to the sound line and from there to the loudspeaker devices 12. The keyed information is also taken to the display 13, but more intelligently than in known speech dialling services, because, when selecting, a plain-text alternative, and not just the selected number, can be displayed.

The XML parser 20 includes particularly an XML control unit 202, a special text parser 204, and a page-request generator 208. The XML control unit 202 sends the TTS module 22 a control code directly over the line 206. If necessary, the text parser edits the menu alternatives into a form suitable for speech, unless this has already been done earlier. Using keyed-in commands and with the aid of XML-page response data, the generator 208 creates a new URL-page request, which the transmission protocol unit 18 sends to the server 8. In this case, the term URL request must be understood broadly—it can refer, for instance, to an account transfer connected to a banking service.

It is also possible to process one or more response menus locally (not shown), in which case the service will be substantially accelerated. The validity of the menu used locally is checked at regular intervals.

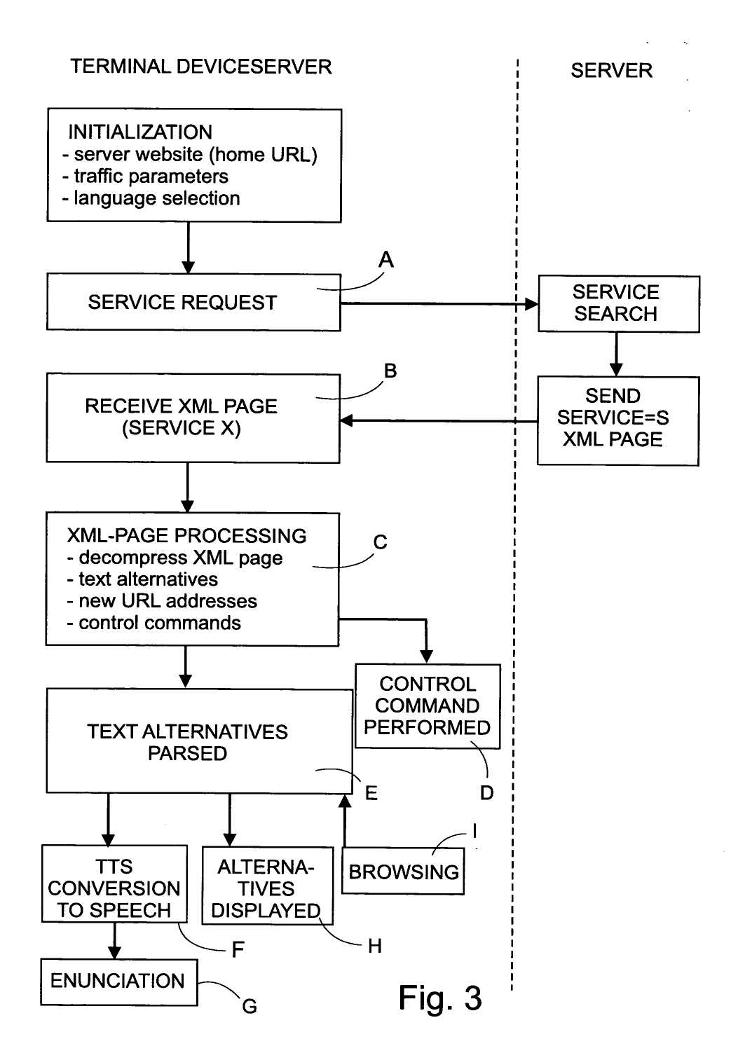

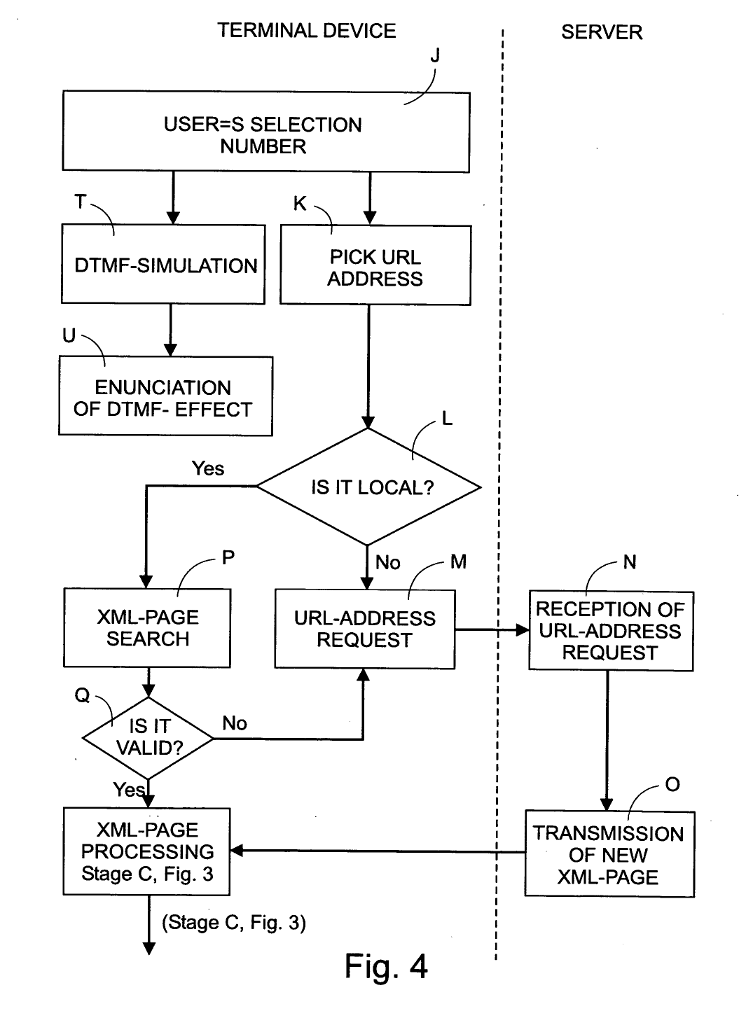

The operation of the service is shown in FIGS. 3 and 4.

The server's XML files are stored on the server. First, initialization takes place, in which the server's address (URL, IP-address), the level of the desired service, the traffic parameters, language, etc. are set. The language selection is particularly important, as it is used to control the speech synthesizer (TTS module).

The service is started when the terminal calls the server (and possibly a specified service), stage A. Naturally, the authentication of the terminal by the server is linked to this. The terminal receives an XML page corresponding to the selected service “X”, stage B. A search operation is initiated on the server, on the basis of which an XML page, containing the speech-service selection alternatives, the corresponding return codes, and control data, is sent to the terminal. Following this, the terminal starts to process the XML, stage C, in which the XML page is broken into parts. In this, the selection alternatives in the form of text, the return addresses corresponding to them, and the control commands are separated. The text alternatives are taken to a special text parser, stage E, in which the text to be converted into speech is finally formed. The text optimized from this is taken to the speech converter, stage F and then to the loudspeaker devices, stage G.

The text to be shown on the display can also be optimized in the text parser, stage H. A browser function for local processing, stage I, is also marked on the figure. This is because the service can be accelerated by permitting browsing of the alternatives backwards and forwards and even permitting local reviewing of the various selection levels, if the XML page contains this information and permits it. In addition to accelerating the service, savings are also made in network resources.

In the actual selection (FIG. 4) the numbers keyed in by the user are converted in DTMF simulation to sound codes, stage T, which are enunciated to the user in order to imitate a traditional service, stage U. In reality, the keying-in is generated as a new page request, by picking a new URL address from the XML page, stage K. If local processing is permitted, a check is made as to whether the page is available locally, stage L. If it is, the page is retrieved for processing, stage P. If the page is not available locally, it is called from the server, stage M, in which the call initiates a new page search, stage N and transmission to the terminal, stage O. In both cases, the new XML page is processed as shown in FIG. 3 (stage C).

Reusing a locally stored XML page requires its validity to be checked, stage Q. Initially, this can take place, for example, only on the basis of the age of the page. At the latest, the validity is checked at the same time as the selection (URL-page request) is sent to the server. If the server detects that an out-of-date page was used by the terminal, it sends an updated XML page, with a notification of the page used being out of date, for a new selection.

The service according to the invention can be constructed in new mobile stations, for example, as a JAVA application (for example, MIDP-J2ME version 2.0).

1. A method for implementing a speech service using a terminal device having loudspeaker devices and communicating with a server, in which
the terminal device sends a call/service request to a server for the speech service,
the server sends speech alternatives corresponding to the service to the terminal device,
the speech alternatives are enunciated to the user as speech messages by the terminal's loudspeaker devices,
the user uses the terminal to select a speech alternative,
the terminal sends the server a service request corresponding to the selection,
characterized in that
the speech alternatives are formed on the server into text files, which are sent to the terminal device, in which they are converted into sound messages corresponding to speech alternatives.

2. A method according to claim 1, characterized in that the speech services are formed into XML pages.

3. A method according to claim 1, characterized in that, on the terminal device, the services are selected by keying-in, a DTMF selection and/or a network's sound response is simulated, and a corresponding sound effect is produced for the user.

4. A method according to claim 1, characterized in that a service menu corresponding to the speech alternatives is also shown on the display of the terminal device.

5. A method according to claim 1, characterized in that a text file, corresponding to the speech alternatives, is saved on the terminal device for later local use and its validity is checked connection with the service selection.

6. A method according to claim 1, characterized in that the language selection of the service is made on the basis of an automatically selected criterion, for example, according to the language setting of the telephone.

7. A method according to claim 1, characterized in that the language and/or speech model is downloaded over a network from the server to the terminal device.

8. A system for implementing a speech service in a communications system, in which there is at least one server and several terminal devices with a telecommunications connection to it, and in which there is a file on the server corresponding to the speech-service alternatives, and in which terminal device there is
a sound line for enunciating the speech-service alternatives to the user,
an input device for receiving the user's input for the selection,
means for transmitting a request to the server according to the selected speech-serviced alternative,
characterized in that the file corresponding to the speech service is a text file and it is arranged to be processed by the terminal device and the terminal device has means for forming a voice message, corresponding to each speech-service alternative, from the said text file.

9. A system according to claim 8, characterized in that the text file containing the speech-service alternatives is of the XML type.

10. A system according to claim 9, characterized in that there is an XML parser in the terminal device, for separating a text portion according to a selected pre-setting for speech conversion.

11. A system according to claim 9, characterized in that the XML parser includes a separate text parser, for processing the separated text for speech conversion.

12. A system according to claim 8, characterized in that the speech-service alternative means for forming a voice message consist of a TTS (Text-to-Speech) element.

13. A system according to claim 8, characterized in that the language and/or speech model is arranged to be downloaded over a network from the server to the terminal device.

14. A terminal device for using a speech service, in which the terminal device is intended to be connected to a server and in which terminal device there is
means for receiving and saving a file corresponding to the speech service,
a sound line for enunciating the speech-service alternatives to the user,
an input device for receiving the user's input for a selection,
means for sending a request according to the selected speech-service alternative to the server,
characterized in that the file corresponding to the speech service is arranged as a text file and there are means in the terminal device for converting this text file into a speech message corresponding to each speech-service alternative.

15. A terminal device according to claim 14, characterized in that, in the terminal device, there are elements for simulating the DTMF selection and/or the sound responses of the network from the user's input and elements for producing a corresponding sound effect for the user.

16. A terminal device according to claim 14, characterized in that the terminal device is arranged to process XML files and there is in it an XML parser for separating the text portion according to the selected presetting for speech conversion.

17. A terminal device according to claim 14, characterized in that the XML parser includes a separate text parser for forming the separated text for speech conversion.

18. A terminal device according to claim 14, characterized in that the means for forming the voice message consist of a TTS (Text-to-Speech) module.

19. A terminal device according to claims 14, characterized in that the terminal device is arranged to select the language of the service on the basis of a selected criterion, for example, according to the language

20. A terminal device according to claims 14, characterized in that the terminal device has a display element.
